(19) United States
(12) Patent Application Publication
(10) Pub. No.: US 2015/0027359 A1
(43) Pub. Date: Jan. 29, 2015

(54) Pneumatic Boat Ski

(71) Applicant: Joseph G. Archer, Hernandez, NM (US)

(72) Inventor: Joseph G. Archer, Hernandez, NM (US)

(73) Assignee: Joseph G. Archer, Hernandez, NM (US)

(21) Appl. No.: 13/952,659

(22) Filed: Jul. 28, 2013

(51) Int. Cl. B60V 3/06; B63B 1/38

(52) U.S. Cl. CPC B60V 3/065; B63B 1/38
USPC 114/289

(57) ABSTRACT

A ski structure for increasing the performance of the vessel is intrinsic to or attached to the hull of the vessel. The ski structure includes a bow portion, a stern portion, an amidships portion, plurality of first sidewalls extending downwards to form one or more upside-down U-channel(s) along the length of the vessel hull and situated to provide balanced support across the width of the vessel. The bow portion includes a rear flap for allowing the entrance of water into the channel and prevents the escape of gas out of the channel(s). The stern portion includes a rear flap for preventing gas from escaping out of the stern portion. An inlet port on the amidships portion and in front of the rear flap for injecting a gas bubble beneath the vessel into the channel and pushing the gas bubble below the waterline and thus resulting in producing lift and effectively eliminating any solid surface part of the vessel hull from being below the water line.

### BACKGROUND OF THE INVENTION

1. Field of the Invention

The present generally relates to a ski structure attached to or intrinsic to the hull of a vessel, and more particularly relates to a ski structure for increasing the performance of the vessel.

2. Description of Related Art

The idea of putting a vapor between a vessel and a body of water defines a class of vessel known as a surface effect ship (SES). It has been around from as early as 1919 with U.S. Pat. No. 1,307,135 and 1922 with U.S. Pat. No. 1,412,848, etc. The purpose of such a modification is to facilitate the passage of a vessel over a body of water. However, previous patents mostly describe specific vessel design features which are only applicable to the manufacturing of new boats as opposed to a means of modifying the literally millions of existing boats.

The first patent cited, U.S. Pat. No. 1,307,135, is very close to the design presented here. It is an exhaust injected ski for a plane. It differs in two important aspects. It does not have a flexible intake flap and it was not envisioned for a marine vessel. As it was written, is would only serve to decrease the surface friction of the ski as opposed to the design presented here which allows a vessel to pass by water in front of the ski following a minimal amount of deflection.

U.S. Pat. Nos. 5,918,562 and 7,703,408 describes a boat ski but it overlooks the fact that a conventional ski produces unequal lift over a fairly limited length of the ski, primarily at the first contact point of the ski with the water. This results in a situation that is similar to that of planning hulls in general, which is the large force acting over a small area resulting in a small area of water being displaced somewhat rapidly. In addition, a significant amount of horsepower is required to even get a vessel up on a ski. Performance wise, it is equivalent to a pontoon boat. The Pneumatic Boat Ski (PBS) effectively distributes the load of the vessel equally over the entire length of the ski and is limited in the force that can be exerted against the water to just a few pounds per square inch (psi). Because of the significant static buoyancy produced by the PBS, it is possible to enable full displacement vessels the ability to plane.

Previous patents describe either multi-cavity air cushion designs or a single large air cushion under a vessel by specific shape and design of the hull. As these designs are at water level and have a large front seal area that can leak in rough water. Also, they tend to perform similar to flat bottom boats thereby foregoing the banked turning characteristics of V-bottom hulls. None of the previous designs specify an elongated, narrower, lower displaced, and attachable chamber as described in this application.

Previous SES designs basically describe a conventional boat hull where the center section of the hull is recessed up in relation to the surface of the water. This means that any displacement of water due to the trapped air under the vessel is accompanied by the displacement of the edges of the hull into the water. This simultaneous displacement results in the edges of the boat hull being dragged through the water. These designs are equivalent to an air assisted pontoon boat.

Previous SES hull designs are all hull designs where the supported air cushion results in a vessel that operates like a flat bottom boat. The PBS, on the other hand, is a floatation channel, that is either intrinsic to or attached to a hull, where for the case of a single channel application, results in a boat that bank in a turn.

Therefore there is a need of ski structure that traps a gas bubble beneath the vessel in a narrow channel and pushes it along below the waterline and thus producing a lift and reducing the cross section of the vessel hull that is below and acting on the water surface; thereby increasing the performance of the ship.

### SUMMARY OF THE INVENTION

In accordance with the teachings of the present invention, a ski structure for increasing the performance of a vessel is provided. The ski structure includes a bow portion with a front flap, a stern portion with a rear flap, an amidships portion having an inlet port and plurality of first sidewalls extending downwards from said amidships portion and forming a seal with the sides of the front flap and the rear flap.

An object of the present invention is to provide a ski structure that traps a gas bubble beneath the vessel in a narrow channel and pushes it along below the waterline thereby producing lift and decreasing the cross section of the vessel acting on the water surface. The gas bubble is injected through an inlet port. The inlet port is positioned near the rear flap and on the amidships portion.

Another object of the present invention is to enable displacement of water within the underside of the ski structure and is comprised of compressed gas. The water displacing gas serves as a deformable hull structure that assumes the shape of the surface of the water being deflected downward as the vessel passes over.

Another object of the present invention is that as the velocity of the vessel approaches infinity, both the amount of water deflected and the distance downward that it is deflected approaches zero. What does not changed is the force acting on the water and the area of the water upon which it is acting upon. In theory, the energy expended to move the water out of the way of the deformable ski structure becomes very small.

Another object of the present invention is to provide a ski structure wherein the amidships portion provides surface effect vessel that banks in a turn when installed on a V or Semi-V hull.

Another object of the present invention is to provide a ski structure longer than the hull of the vessel to augment the vessel's weight capacity and overall improved performance. A longer and narrower channel effectively converts a short, fat vessel into a long narrow vessel as it applies resistance of movement through the water.

Another object of the present invention is not to spread the air bubble beneath the vessel over the width of the vessel. Further, the smaller the cross-section and surface area of the gas chamber is compensated for by the ability to increase the pressure of the gas within the channel.

### BRIEF DESCRIPTION OF DRAWINGS

FIG. 1 illustrates a bottom perspective of the ski structure 100 for increasing the performance of the vessel, in accordance with a preferred embodiment of the present invention;

FIG. 2 illustrates a side view showing water level inside the channel of the ski structure under forward motion, in accordance with an exemplary embodiment of the present invention;

FIG. 3 illustrates a perspective view of the ski structure attached on a vessel in accordance with a preferred embodiment of the present invention;

FIG. 4 illustrates a perspective view of a double ski structure attached on a vessel in accordance with another preferred embodiment of the present invention; and

FIG. 5 illustrates a bottom perspective view of a single hull structure intrinsic to and attached on a vessel in accordance with another preferred embodiment of the present invention; and

FIG. 6 illustrates a front view of the inclined hull sidewalls in accordance with another preferred embodiment of the present invention.

### DETAILED DESCRIPTION OF DRAWINGS

While this technology is illustrated and described in a preferred embodiment, the ski structure attached to hull of the ship for increasing the performance of the ship may be produced in many different configurations, forms and materials. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

Reference will now be made in detail to several embodiments of the invention which are illustrated in the accompanying drawings. Wherever feasible and convenient, the same reference numerals are used in the figures and the description to refer to the same or like parts. The drawings are in a simplified form and not to precise scale. For purposes of convenience and clarity only, directional terms, such as top, bottom, left, right, up, down, over, above, below, beneath, rear, and front may be used with respect to the accompanying drawings. These and similar directional terms should not be strictly construed to limit the scope of the invention. In addition, words such as attached, affixed, coupled, connected and similar terms with their inflectional morphemes are used interchangeably, unless the difference is noted or made otherwise clear from the context. These words and expressions do not necessarily signify direct connections, but include connections through mediate components and devices.

Definitions:

Bow Portion: The bow is the forward part of the ski structure or hull structure.
Stern Portion: The stern is rear part of the ski structure or hull structure.
Amidships Portion: The middle portion of the ski structure or hull structure.

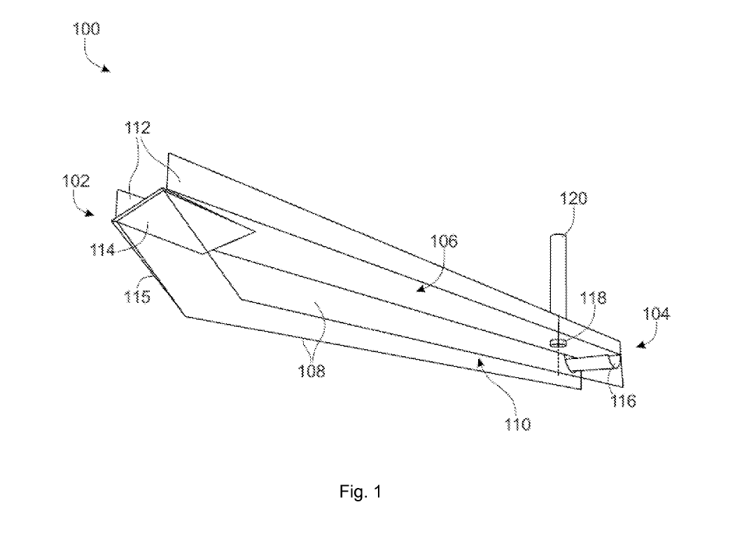

FIG. 1 illustrates a perspective view of a ski structure 100 that would be attached to the hull of the vessel for increasing performance of the vessel (Vessel not shown in FIG. 1). The ski structure 100 includes a bow portion 102, a stern portion 104, an amidships portion 106 and plurality of first sidewalls 108 (such as 108a and 108b) extending downward from the amidships portion 106 to form a channel 110 along the bow portion 102, the stern portion 104 and the amidships portion 106. In a preferred embodiment of the present invention the channel 110 is an upside down U-channel.

The bow portion 102 includes a deflectable front flap 114 for allowing the entering of water while preventing the escape of gas from the channel 110. In another embodiment of the present invention, the depth of the sidewalls 108 and the front flap 114 and the rear flap 116 determines the static buoyancy of the ski structure 100. Further, the bow portion 102 having a tapered leading edge 115 on the plurality of first sidewalls 108 to deflect foreign objects.

The stern portion 104 includes a rear flap 116 for preventing gas from escaping out of the stern portion 104 by maintaining a seal to trap gas within the channel 110. The plurality of first sidewalls 108 are extended downwards from the amidships portion 106 to form a seal with the sides of the front flap 114 and the rear flap 116 to trap gas at an operating pressure. In another embodiment of the present invention, the rear lap 116 is a gas filled bag to form a sealing conforming to the surface of the water regardless of the vessel list or water surface choppiness. The gas filled bag being controlled with the gas pressure and further remains constant regardless of the depth that the seal extends relative to the plurality of first sidewalls 108.

The amidships portion 106 includes an inlet port 118 in front of the rear flap 116 for injecting a gas bubble beneath the vessel into the channel 110 and pushing the gas bubble below the waterline, thus resulting in producing lift and decreasing the cross section of the vessel hull located beneath the water surface.

In another embodiment of the present invention the ski structure 100 further includes plurality of second sidewalls 112 for attaching the amidships portion 106 with the hull of the vessel (not shown in FIG. 1).

In another embodiment of the present invention the ski structure 100 further includes a pipe 120 attached to the inlet port 118 to allow injection of gas bubbles into the channel 110.

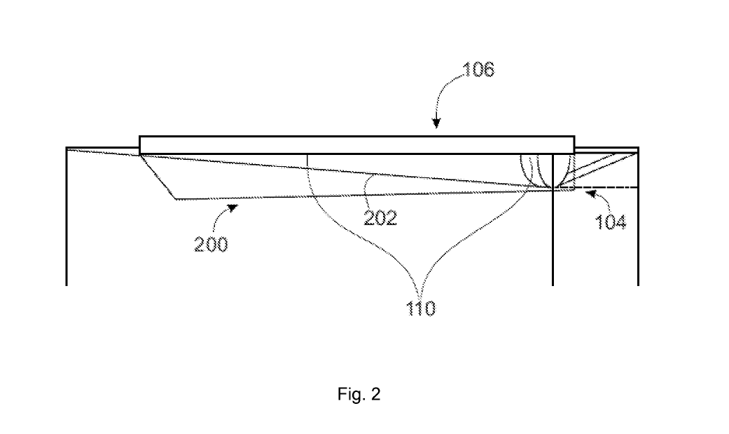

FIG. 2 illustrates a side view showing water level inside the channel 110 of the ski structure 200. In an exemplary embodiment of the present invention, as the ski structure 200 moves on the water surface, a waterline 202 is created within the channel 110. The depth of the channel 110 from the amidships portion 106 be sufficient to raise the vessel out of the water enough effective plane on top of the water and to minimize the potential leakage of trapped gases due to rough seas.

In another embodiment of the present invention, the front flap further comprising a membrane 204 bonded to the plurality of first sidewalls for laying horizontally along the amidships portion 106 to allow water to pass by and assume a vertical orientation to trap the gas bubble when said vessel is motionless.

In a preferred embodiment of the present invention, as the thrust is applied the air bubble may only resist the water in front of it by a force equal to the air pressure within the ski. As the boat moves forward, air is trapped on top of the inrushing water. The trapped air continues to exert the same pressure on the underside of the vessel as it does on the top of the inrushing water at all points within the channel 110.

As the boat moves over the water, the water is gradually pushed to the lowest point at the rear end of the channel 110. This gradual displacement accounts for the reduced energy required to displace the water in front of the water bubble. With the increase in the speed of the vessel, the level of the water in the channel 110 increases.

The energy required to slide the vessel over the water surface is minimized as both the amount of water displaced and the degree to which is displaced from within the front of vessel is minimized. In a preferred embodiment of the present invention the ski structure 200 is deformable and thus the power demands decrease exponentially as a function of speed.

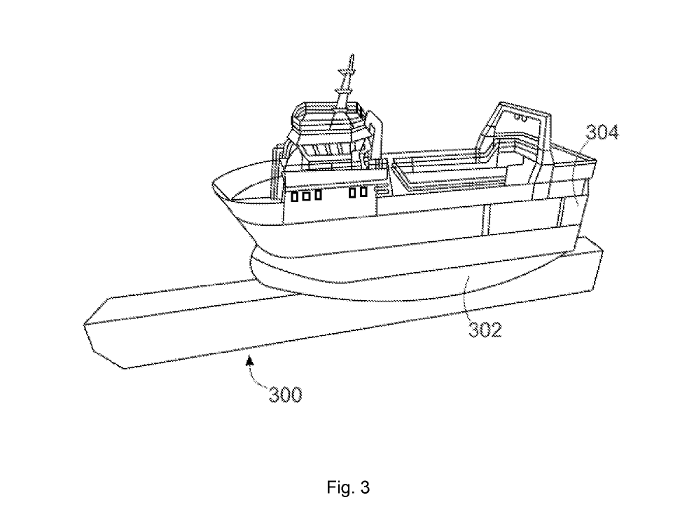

FIG. 3 illustrates a perspective view of a single ski structure 300 attached on the hull 302 of the vessel 304. In another preferred embodiment of the present invention the amidships portion 106 provides surface effect vessel that banks in a turn when installed on a V or Semi-V hull. The plurality of first sidewalls 108 are inset from the sides of the vessel 304 in order to provide lateral stability. As the vessel lists to a side, the gas at the bottom of the ski acts to roll the vessel 304 as the center of lift is shifted from the center of the vessel 304 to the side, thus tending towards lateral stability. However, as the vessel lists, the amount of gas that can be trapped within the ski decrease as the depth of one sidewall decreases as the depth of the other sidewall increases. This tendency towards instability is only an issue for a single ski application primarily for a motionless vessel. As the vessel moves across the water, the movement of the hull surface that extends beyond the position of the sidewall passing through the water prevents the rolling of the vessel.

In another embodiment of the present invention, the plurality of first sidewalls 108 being sufficiently deep to provide a static buoyancy sufficient to raise the bottom of the vessel 304 far enough up towards the water surface to achieve enough speed to effectively plane along the water surface.

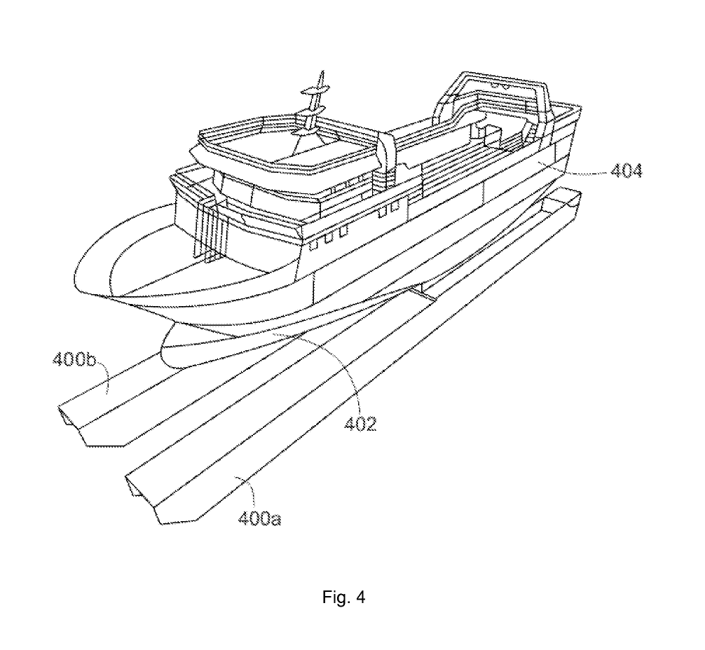

FIG. 4 illustrates a perspective view of a double ski structure 400 such as 400a and 400b attached on the hull 402 of the vessel 404, in exemplary embodiment of the present invention.

In another embodiment of the present invention, the length of the amidships portion may exceeds the length of the hull of the vessel to augment vessels weight capacity and further improves the performance.

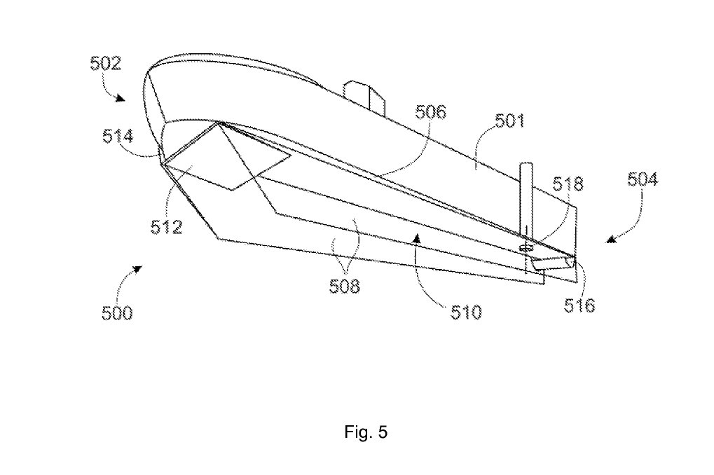

FIG. 5 illustrates a perspective view of a hull structure 500 attached to the vessel 501, in another exemplary embodiment of the present invention. The hull structure 500 includes a bow portion 502, a stern portion 504, an amidships portion 506, plurality of hull sidewalls 508 to form an upside down U channel 510 along said bow portion 502, stern portion 504 and said amidships portion 506. The plurality of hull sidewalls 508 extend downwards from the amidships portion 506.

The bow portion 502 includes a tapered front flap 512 for allowing the entering of water while preventing the escape of gas from the channel 510. In another embodiment of the present invention, the depth of the front flap 512 against the water surface controls the water pressure inside the channel 510 for a motionless vessel. When the vessel is at sufficient speed, the pressure within the ski is whatever is needed to support the full weight of the vessel. Further, the bow portion 502 having a tapered leading edge 514 on the plurality of hull sidewalls 508 to deflect foreign objects.

The stern portion 504 includes a rear flap 516 for preventing gas from escaping out of the stern portion 504 by maintaining a seal to trap gas within the channel 510. The plurality of hull sidewalls 508 are extended downwards from the amidships portion 506 to form a seal with the sides of the front flap 512 and the rear flap 516 to trap gas at an operating pressure. In another embodiment of the present invention, the rear lap 516 is a gas filled bag to form a sealing conforming to the surface of the water regardless of the position of the plurality of hull sidewalls 508. The gas filled bag being controlled with the gas pressure and further remains constant regardless of the depth of the sealing extending relative to the plurality of hull sidewalls 508.

The amidships portion 506 includes an inlet port 518 in front of the rear flap 516 for injecting a gas bubble beneath the vessel into the channel 510 and pushing the gas bubble below the waterline, thus resulting in producing lift and decreasing the cross section of the vessel hull that is below and acting on the water surface.

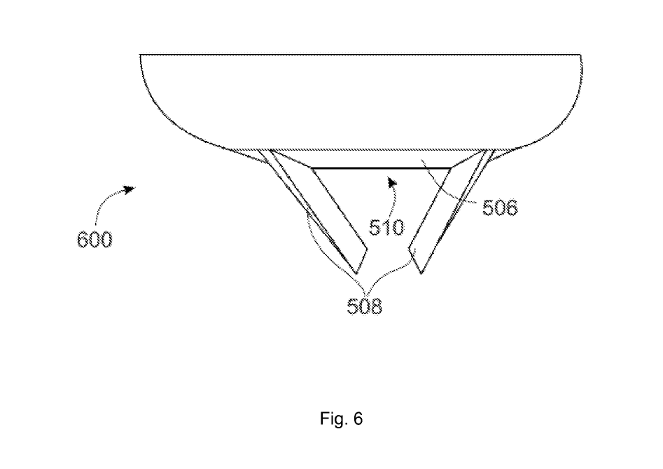

FIG. 6 illustrates a front view of the hull structure 600 attached on the amidships portion 506 of the vessel 501, in another preferred embodiment of the present invention. The plurality of hull sidewalls 508 are slanted significantly inward from the amidships portion 506 to maximize stability in the event of vessel 501 listing by decreasing the effect of gas at the bottom of the channel 510 in acting to roll the vessel 501 as the center of lift moves to the side from the centerline of the vessel 501.

The present invention offers various advantages. The invention allows reducing the rate of displacement and volume of water that must be displaced in order for the vessel to pass and thus increases the performance of the vessel. The present invention brings cost-effective means to the vessel owners to create a narrow channel under the vessel for trapping the gas bubble.

The foregoing discussion discloses and describes merely exemplary embodiments of the present invention. One skilled in the art will readily recognize from such discussion and from the accompanying drawings that various changes, modifications and variations can be made therein without departing from the spirit and scope of the invention.

1. A ski structure attached to hull of the vessel, said ski structure for increasing the performance of the vessel, said ski structure comprising:
a bow portion; a stern portion; an amidships portion; and plurality of first sidewalls to form an upside down U channel along said bow portion, stern portion and said amidships portion; wherein
said bow portion a front flap for allowing the entering of water while preventing the escape of gas from said upside down U channel;
said stern portion having a rear flap, said rear flap for preventing gas from escaping out of said stern portion by maintaining a seal to trap gas within said channel;
said plurality of first sidewalls extending downwards from said amidships portion to form a seal with the sides of said front flap and said rear flap to trap vapor at an operating pressure; and
said amidships portion having an inlet port in front of said rear flap for injecting a gas bubble beneath the vessel into said channel and pushing the gas bubble below the waterline, thus resulting in producing lift and decreasing the weight of the vessel acting on the water surface.

2. The ski structure according to claim 1 wherein length of said front flap minimizes potential leakage of trapped gas bubbles from said upside down U channel.

3. The ski structure according to claim 1 wherein said amidships portion provide surface effect vessel that banks in a turn when installed on a V or Semi-V hull.

4. The ski structure according to claim 1 wherein said bow portion having a tapered leading edge on said plurality of first sidewalls to deflect foreign objects.

5. The ski structure according to claim 1 wherein the length of said amidships portion exceeds the length of the hull of the vessel to augment vessel's weight capacity and further improves the performance.

6. The ski structure according to claim 1 wherein said plurality of first sidewalls slanted significantly inward along said amidships portion to maximize stability in the event of vessel listing.

7. The ski structure according to claim 1 wherein said plurality of first sidewalls being inset from the sides of said vessel in order to provide lateral and longitudinal stability.

8. The ski structure according to claim 1 wherein said plurality of first sidewalls being sufficiently deep to provide a static buoyancy sufficient to raise the bottom of the vessel far enough up towards the water surface so that a vessel can achieve enough speed to effectively plane along the water surface.

9. The ski structure according to claim 1 wherein said front flap further comprising a membrane bonded to said plurality of first sidewalls for laying horizontally along said amidships portion to allow water to pass by and assume a vertical orientation to trap the gas bubble when said vessel is motionless.

10. The ski structure according to claim 1 wherein said rear flap further comprising a gas filled bag to form a seal conforming to the surface of the water regardless of the degree of vessel listing or water surface choppiness.

11. The ski structure according to claim 10 wherein said gas filled bag being controlled with the gas pressure and further remains constant regardless of the depth of the sealing extending relative to said plurality of first sidewalls.

12. The ski structure according to claim 1 further comprising plurality of second sidewalls for attaching said amidships portion with the hull of the vessel.

13. A hull structure intrinsically attached to the bottom of a vessel, said hull structure for increasing the performance of the vessel and said hull structure comprising:
a bow portion; a stern portion; an amidships portion; plurality of hull sidewalls to form an upside down U channel along said bow portion, stern portion and said amidships portion; wherein
said bow portion a front flap for allowing the entering of water while preventing the escape of gas;
said stern portion having a rear flap, said rear flap for preventing gas from escaping out of said stern portion by maintaining a seal to trap gas within said channel;
said plurality of hull sidewalls extending downwards from said amidships portion to form a seal with the sides of said front flap and said rear flap to trap vapor at an operating pressure; and
said amidships portion having an inlet port in front of said rear flap for injecting a gas bubble beneath the vessel into said channel and pushing the gas bubble below the waterline, thus resulting in producing lift and decreasing the cross section of the vessel below the water surface.

14. The hull structure according to claim 13 wherein length of said front flap minimizes potential leakage of trapped gas bubbles from said upside down U channel.

15. The hull structure according to claim 13 wherein said amidships portion provide surface effect vessel that banks in a turn when installed on a V or Semi-V hull.

16. The hull structure according to claim 13 wherein the length of said amidships portion exceeds the length of the hull of the vessel to augment vessel's weight capacity and further improves the performance.

17. The hull structure according to claim 13 wherein said plurality of hull sidewalls slanted significantly inward from said amidships portion to maximize stability in the event of vessel listing.

18. The hull structure according to claim 13 wherein said plurality of hull sidewalls being inset from the sides of said vessel to provide lateral stability.

19. The hull structure according to claim 13 wherein said plurality of hull sidewalls being sufficiently deep to provide a static buoyancy sufficient to raise the bottom of the vessel far enough up towards the water surface to achieve enough speed to effectively plane along the water surface.

20. The hull structure according to claim 13 wherein said front flap further comprising a membrane bonded to said plurality of hull sidewalls for laying horizontally along said amidships portion to allow water to pass by and assume a vertical orientation to trap the gas bubble when said vessel is motionless.
